(19) United States
(12) Patent Application Publication
(10) Pub. No.: US 2017/0324101 A1
(43) Pub. Date: Nov. 9, 2017

(54) PROACTIVE ANODE FLOODING REMEDIATION

(71) Applicant: GM GLOBAL TECHNOLOGY OPERATIONS LLC, DETROIT, MI (US)

(72) Inventors: MANISH SINHA, ROCHESTER HILLS, MI (US); JAMES A. LEISTRA, PENFIELD, NY (US); SERGIO E. GARCIA, COMMERCE TOWNSHIP, MI (US); MARK W. ROTH, WATERFORD, MI (US)

(21) Appl. No.: 15/146,698

(22) Filed: May 4, 2016

(51) Int. Cl. H01M 8/04119; H01M 8/04828; H01M 8/04746; H01M 8/04089; H01M 8/04537; H01M 8/04492; H01M 8/0432; H01M 16/00; H01M 8/04791

(52) U.S. Cl. CPC H01M 8/04179; H01M 16/006; H01M 8/0494; H01M 8/04843; H01M 8/04798; H01M 8/04104; H01M 8/04589; H01M 8/045; H01M 8/04328; H01M 8/04783

(57) ABSTRACT

A method for performing one or more proactive remedial actions to prevent anode flow-field flooding in an anode side of a fuel cell stack at low stack current density. The method includes identifying one or more trigger conditions that could cause the anode flow-field to flood with water, and performing the one or more proactive remedial actions in response to the identified trigger conditions that removes water from the anode side flow-field prior to the anode flooding occurring.

### BACKGROUND OF THE INVENTION

### Field of the Invention

This invention relates generally to a system and method for providing a proactive remedial action in response to a determined potential for anode flow-field flooding in an anode side of a fuel cell stack and, more particularly, to a system and method for performing one or more proactive remedial actions, such as increasing anode pressure bias, initiating a reactive bleed, increasing a hydrogen concentration set-point, pulsing the stack power and/or pulsing the anode pressure, in response to a determined potential for anode flow-field flooding in an anode side of a fuel cell stack.

### Discussion of the Related Art

A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free hydrogen protons and electrons. The hydrogen protons pass through the electrolyte to the cathode. The electrons from the anode cannot pass through the electrolyte, and are directed through a load to perform work before being sent to the cathode. Proton exchange membrane fuel cells (PEMFC) are a popular fuel cell type for vehicles, and generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer, where the catalytic mixture is deposited on opposing sides of the membrane. The combination of the anode catalytic mixture, the cathode catalytic mixture and the membrane define a membrane electrode assembly (MEA). The membranes block the transport of gases between the anode side and the cathode side of the fuel cell stack while allowing the transport of protons to complete the anodic and cathodic reactions on their respective electrodes.

Several fuel cells are typically combined in a fuel cell stack to generate the desired power. A fuel cell stack typically includes a series of flow field or bipolar plates positioned between the several MEAs in the stack, where the bipolar plates and the MEAs are positioned between two end plates. The bipolar plates include an anode side and a cathode side for adjacent fuel cells in the stack. Anode gas flow channels are provided on the anode side of the bipolar plates that allow the anode reactant gas to flow to the respective MEA. Cathode gas flow channels are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

The MEAs in the fuel cells are permeable and thus allow nitrogen in the air from the cathode side of the stack to permeate through and collect in the anode side of the stack, often referred to as nitrogen cross-over. Even though the anode side pressure may be slightly higher than the cathode side pressure, cathode side partial pressures will cause air to permeate through the membrane. Nitrogen in the anode side of the fuel cell stack dilutes the hydrogen such that if the nitrogen concentration increases above a certain percentage, such as 50%, fuel cells in the stack may become starved of hydrogen. If a fuel cell becomes hydrogen starved, the fuel cell stack will fail to produce adequate electrical power and may suffer damage to the electrodes in the fuel cell stack. Thus, it is known in the art to provide a bleed valve in the anode exhaust gas output line of the fuel cell stack to remove nitrogen from the anode side of the stack. The fuel cell system control algorithms will identify a desirable minimum hydrogen gas concentration in the anode, and cause the bleed valve to open when the gas concentration falls below that threshold, where the threshold is based on stack stability.

As is well understood in the art, fuel cell membranes operate with a certain relative humidity (RH) so that the ionic resistance across the membrane is low enough to effectively conduct protons. The relative humidity of the cathode outlet gas from the fuel cell stack is typically controlled to control the relative humidity of the membranes by controlling several stack operating parameters, such as stack pressure, temperature, cathode stoichiometry and the relative humidity of the cathode air into the stack. Currently, fuel cell stacks are often times run “wet” where the relative humidity of both the cathode side and the anode side of the fuel cell stack is at 100% or higher depending on the particular operating conditions of the stack.

During operation of the fuel cell stack, moisture from the MEAs and external humidification may enter the anode and cathode flow channels. At low cell power demands, typically below 0.2 A/cm², water may accumulate within the flow channels because the flow rate of the reactant gas is too low to force the water out of the channels. For example, at low power levels, such as during vehicle idling, the stack current density is low and hydrogen is not being pumped into the anode side by the injector at a very high duty cycle. Thus, less hydrogen is available to push water out of the flow channels, often times resulting in hydrogen starvation of some of the cells. Wet stack operation can lead to fuel cell stability problems due to water build up, and could also cause anode starvation resulting in carbon corrosion. In addition, wet stack operation can be problematic in freeze conditions due to liquid water freezing at various locations in the fuel cell stack.

As water accumulates in the stack, droplets form in the flow channels. As the size of the droplets increases, the flow channel is closed off, and the reactant gas is diverted to other flow channels because the channels are in parallel between common inlet and outlet manifolds. As the droplet size increases, surface tension of the droplet may become stronger than the delta pressure trying to push the droplets to the exhaust manifold so the reactant gas may not flow through a channel that is blocked with water, the reactant gas cannot force the water out of the channel. Those areas of the membrane that do not receive reactant gas as a result of the channel being blocked will not generate electricity, thus resulting in a non-homogenous current distribution and reducing the overall efficiency of the fuel cell. As more and more flow channels are blocked by water, the electricity produced by the fuel cell decreases, where a cell voltage potential less than 200 mV is considered a cell failure. Because the fuel cells are electrically coupled in series, if one of the fuel cells stops performing, the entire fuel cell stack may stop performing.

The minimum cell voltage of the fuel cells in a fuel cell stack is a very important parameter for monitoring the stack health and protecting the stack from reverse voltage damage. In addition, the minimum cell voltage is used for many purposes for controlling the fuel cell stack, such as power limitation algorithms, anode nitrogen bleeding, diagnostic functions, etc.

Typically, the voltage output of every fuel cell in a fuel cell stack is monitored so that the fuel cell system knows if a fuel cell voltage is too low, indicating a possible failure. As is understood in the art, because all of the fuel cells are electrically coupled in series, if one fuel cell in the stack fails, then the entire stack will fail. Certain remedial actions can be taken for a failing fuel cell as a temporary solution until the fuel cell vehicle can be serviced, such as increasing the flow of hydrogen and/or increasing the cathode stoichiometry.

### SUMMARY OF THE INVENTION

The present disclosure describes a system and method for performing one or more proactive remedial actions to prevent anode flow-field flooding in an anode side of a fuel cell stack at low stack current density. The method includes identifying one or more trigger conditions that could cause the anode flow-field to flood with water, and performing the one or more proactive remedial actions in response to the identified trigger conditions that removes water from the anode side flow-field prior to the anode flooding occurring.

Additional features of the present invention will become apparent from the following description and appended claims, taken in conjunction with the accompanying drawings.

### BRIEF DESCRIPTION OF THE DRAWINGS

FIG. 1 is an illustration of a vehicle including a fuel cell system; and

FIG. 2 is a simplified schematic block diagram of a fuel cell system.

### DETAILED DESCRIPTION OF THE EMBODIMENTS

The following discussion of the embodiments of the invention directed to a system and method for taking proactive remedial actions to prevent anode flow-field flooding in a fuel cell stack is merely exemplary in nature, and is in no way intended to limit the invention or its applications or uses. For example, the fuel cell system discussed herein has particular application for use on a vehicle. However, as will be appreciated by those skilled in the art, the system and method of the invention may have other applications.

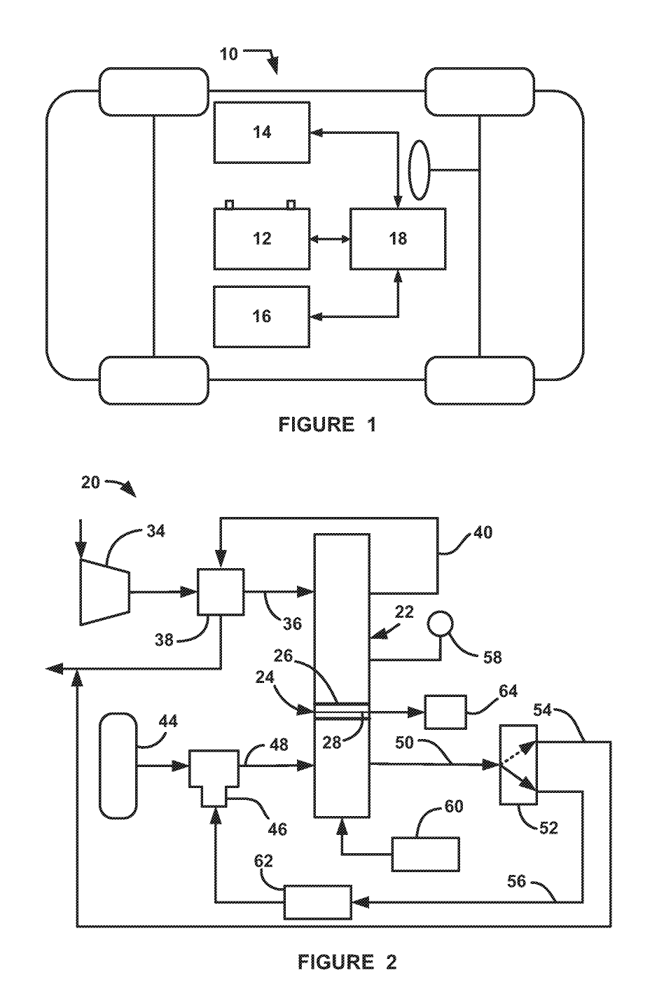

FIG. 1 is a simplified view illustrating a hybrid fuel cell vehicle 10 that includes a high-voltage battery 12, a fuel cell stack 14, a propulsion unit 16 and a controller 18. The controller 18 represents all of the control modules, processors, electronic control units, memory and devices necessary for the operation and calculations for taking proactive remedial actions to prevent anode flow-field flooding as discussed herein.

FIG. 2 is a schematic block diagram of a fuel cell system 20 including a fuel cell stack 22, where the fuel cell system 20 has particular application for use on the vehicle 10. The stack 22 includes a series of fuel cells of the type discussed above, represented generally by a fuel cell 24 including opposing bipolar plates 26 having an MEA 28 therebetween. A compressor 34 provides an airflow to the cathode side of the fuel cell stack 22 on a cathode input line 36 through a water vapor transfer (WVT) unit 38 that humidifies the cathode input air. A cathode exhaust gas is output from the stack 22 on a cathode exhaust gas line 40 that directs the cathode exhaust gas to the WVT unit 38 to provide the humidity to humidify the cathode input air. Water in the cathode exhaust gas at one side of the membrane is absorbed by the membrane and transferred to the cathode air stream at the other side of the membrane. The fuel cell system 20 also includes a source 44 of hydrogen fuel, typically a high pressure tank, that provides hydrogen gas to an injector 46 that injects a controlled amount of the hydrogen gas to the anode side of the fuel cell stack 22 on an anode input line 48. Although not specifically shown, one skilled in the art would understand that various pressure regulators, control valves, shut-off valves, etc. would be provided to supply the high pressure hydrogen gas from the source 44 at a pressure suitable for the injector 46. The injector 46 can be any injector suitable for the purposes discussed herein.

An anode effluent gas is output from the anode side of the fuel cell stack 22 on an anode output line 50, which is provided to a bleed valve 52. As discussed above, nitrogen cross-over from the cathode side of the fuel cell stack 22 dilutes the hydrogen gas in the anode side of the stack 22, thereby affecting fuel cell stack performance. Therefore, it is necessary to periodically bleed the anode effluent gas from the anode sub-system to reduce the amount of nitrogen therein. When the system 20 is operating in a normal non-bleed mode, the bleed valve 52 is in a position where the anode effluent gas is provided to a recirculation line 56 that recirculates the anode gas to the injector 46 to operate it as an ejector or pump to provide recirculated hydrogen gas back to the anode input of the stack 22. A water separator 62 is provided in the line 56 to remove water from the recirculated anode affluent in a manner well understood by those skilled in the art. When a bleed is commanded to reduce nitrogen in the anode side of the stack 22, the bleed valve 52 is positioned to direct the anode effluent gas to a by-pass line 54 that combines the anode effluent gas with the cathode exhaust gas on the line 40, where the hydrogen gas is diluted to be suitable for the environment.

The system 20 also includes a pressure sensor 58 that measures the pressure in the anode sub-system. The system 20 further includes a cell voltage monitoring unit 64 for monitoring the voltage of each fuel cell 24 in the stack 22, and providing an indication of a minimum cell voltage. The system 20 further includes a battery 60 that provides supplemental power to the system 20 for various purposes including those discussed herein, where the battery 60 may be a 12 volt accessory battery on the vehicle 10 or other battery associated with the system as would be well understood by those skilled in the art. There are times during operation of the system 20, where the stack 22 will be generating power, but that power is not needed to propel the vehicle 10. In those situations, it is known in the art to charge the battery 60 for later use.

As will be discussed in detail below, the present invention proposes a system and method for taking one or more proactive remedial actions in response to detecting certain trigger conditions indicating that anode flow-field flooding for at least some of the fuel cells may occur in the near future to prevent flooding of anode flow channels in the anode side of the fuel cell stack 22.

A first trigger condition can include identifying that the stack current density is below a predetermined value, such as 0.05 A/cm², for a predetermined period of time, such as 10 minutes, which could be an extended idle time for a vehicle. At low stack current densities, the hydrogen gas flow may not be high enough to push water out of the anode flow channels.

A second trigger condition can include that the stack temperature is below a certain value, such as 30° C., when a key on condition is identified, which could occur during a cold start or a freeze start, which could be an indication that water may enter the anode flow channels.

A third trigger condition could include that the stack 22 is operating at a higher RH than normal, such as 150% RH, which could occur during various fuel cell stack operating conditions, such as during a stack voltage recovery operation where it is known in the art to provide excessive water in the stack 22 to remove contaminates from the fuel cell electrodes. A typical fuel cell system will include an RH model that monitors the RH of the fuel cell stack 22 to identify when the RH exceeds a predetermined value.

A fourth trigger condition may include monitoring an anode water accumulation model that predicts anode flooding of the anode flow channels. As is well understood by those skilled in the art, anode water accumulation models are known that can predict anode flow-field flooding and employ factors in an anode water crossover from the cathode side and some heuristic based water removal based on injector operation.

A fifth trigger condition may include monitoring the minimum cell voltage of the fuel cells in the fuel cell stack 22 by, for example, the cell voltage monitoring unit 64, and providing a flag that a remedial action needs to be taken if the minimum cell voltage falls below some predetermined value.

One, some or all of these trigger conditions are monitored so that the algorithm can perform certain proactive remedial action in response to a situation for potential anode flow-field flooding in the near future. Those proactive remedial actions can include one or more of the following.

A first remedial action can include increasing the anode pressure bias, i.e., inject more hydrogen gas into the anode side of the fuel cell stack 22, so that the pressure in the anode side is above the cathode side. For example, the anode pressure may be increased to 60-80 kPa above the cathode side pressure, which helps to momentarily increase injector flow which results in higher recirculation and may help clear the water from the flow-fields. Further, the higher anode side pressure allows more water to be removed during an anode bleed event.

A second remedial action can include trigging a proactive bleed, and especially during the higher anode pressure event, so that more water is pushed out of the anode flow-field channels.

A third remedial action can include increasing the hydrogen gas concentration set-point, which also causes an increase in the bleed frequency, where the increased proactive bleed allows more water to be removed from the anode side of the fuel cell stack.

A fourth remedial action can include pulsing the power of the fuel cell stack 22 by periodically providing more reactant gases thereto, which would increase the power output of the fuel cell stack 22 presumably at a time when more power is not commanded. As above, by pulsing the power, more hydrogen is delivered to the anode side flow channels, which acts to push water out of the flow channels. The excess power generated by the stack 22 can be used to recharge the battery 60, or can be sinked into other elements, such as pumps, the compressor 34, etc. The PWM power pulsing can be calibrated for a particular system. For example, in one embodiment, the power can be pulsed to 0.07 A/cm² for 30 seconds every 360 seconds, which is a duty cycle of about 1/12. Further, if the compressor 34 is providing excess air during the pulse power, that air can bypass the fuel cell stack 22 and be sent to the exhaust gas line. In one embodiment, the compressor 34 operates some minimum speed, which is above the speed necessary for idle conditions, where the pulsed power may use the available cathode air flow without the speed of the compressor 34 ramping up.

A fifth remedial action can include pulsing the anode pressure to increase the pressure bias by increasing the duty cycle of the injector 46 without opening the bleed valve 52 so that the hydrogen is not wasted, for example, increase the bias from 20 kPa to 80 kPa, where the anode exhaust gas may be recirculated back to the injector. This may force water out of the fuel cell stack 22 to be collected by the water separator, which would remove water from the flow field in the anode side of the fuel cell stack 22.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for preventing flooding of an anode flow-field in a fuel cell stack, said method comprising:
identifying one or more trigger conditions that could cause the anode flow-field to flood with water; and
performing one or more proactive remedial actions in response to the one or more trigger conditions that removes water from the anode side flow-field prior to the anode flooding occurring.

2. The method according to claim 1 wherein identifying one or more trigger conditions includes determining that a stack current density has fallen below a predetermined stack current density for a predetermined period of time.

3. The method according to claim 2 wherein the predetermined stack current density is 0.05 A/cm² and the predetermined time is 10 minutes.

4. The method according to claim 1 wherein identifying one or more trigger conditions includes determining that a stack temperature has fallen below a predetermined temperature value.

5. The method according to claim 4 wherein the predetermined temperature value is 30° C.

6. The method according to claim 1 wherein identifying one or more trigger conditions includes determining that the stack is operating at a higher relative humidity than normal.

7. The method according to claim 6 wherein the normal relative humidity is about 150%.

8. The method according to claim 1 wherein identifying one or more trigger conditions includes using an anode water accumulation model to determine that the amount of water in the anode flow-field could cause anode flow-field flooding.

9. The method according to claim 8 wherein the anode water accumulation model employs anode water crossover from a cathode of the stack and a heuristic based water removal based on injector operation.

10. The method according to claim 1 wherein performing one or more proactive remedial actions includes increasing an anode pressure bias.

11. The method according to claim 1 wherein performing one or more proactive remedial actions includes causing a proactive anode side bleed event to occur.

12. The method according to claim 1 wherein performing one or more proactive remedial actions includes increasing a hydrogen gas concentration set-point for operation of the fuel cell stack.

13. The method according to claim 1 wherein performing one or more proactive remedial actions includes pulsing stack output power.

14. The method according to claim 13 wherein excess power caused by pulsing the power of the fuel cell stack is used to recharge a battery or is sinked to a device.

15. The method according to claim 13 wherein causing power pulsing of the fuel cell stack includes pulsing the power to 0.07 A/cm² for 30 seconds every 360 seconds.

16. The method according to claim 1 wherein performing one or more proactive remedial actions includes pulsing anode pressure from a normal bias to a higher bias.

17. A method for preventing flooding of an anode flow-field in a fuel cell stack, said method comprising:
identifying one or more trigger conditions that could cause the anode flow-field to flood with water, wherein the one or more trigger conditions are selected from the group consisting of determining that a stack current density has fallen below a predetermined stack current density for a predetermined period of time, determining that a stack temperature has fallen below a predetermined temperature value, determining that the stack is operating at a higher relative humidity than normal, and using an anode water accumulation model to determine that the amount of water in the anode flow-field could cause anode flow-field flooding; and
performing one or more proactive remedial actions in response to the one or more trigger conditions that removes water from the anode side flow-field prior to the anode flooding occurring, wherein the one or more proactive remedial actions are selected from the group consisting of increasing an anode pressure bias, causing a proactive anode side bleed event to occur, increasing a hydrogen gas concentration set-point for operation of the fuel cell stack, pulsing stack output power, and pulsing anode pressure from a normal bias to a higher bias.

18. The method according to claim 17 wherein the predetermined stack current density is 0.05 A/cm² and the predetermined time is 10 minutes.

19. The method according to claim 17 wherein the predetermined temperature value is 30° C.

20. A method for preventing flooding of an anode flow-field in a fuel cell stack, said method comprising:
identifying that a voltage of a fuel cell in the fuel cell stack has fallen below a predetermined minimum cell voltage that could cause the anode flow-field to flood with water; and
performing one or more remedial actions in response to the fuel cell voltage falling below the predetermined minimum cell voltage that removes water from the anode side flow-field prior to the anode flooding occurring, wherein the one or more remedial actions are selected from the group consisting of increasing an anode pressure bias, causing a proactive anode side bleed event to occur, increasing a hydrogen gas concentration set-point for operation of the fuel cell stack, pulsing stack output power, and pulsing anode pressure from a normal bias to a higher bias.
